(19) United States
(12) Patent Application Publication
(10) Pub. No.: US 2012/0140244 A1
(43) Pub. Date: Jun. 7, 2012

(54) METHOD FOR OPTICALLY SCANNING AND MEASURING AN ENVIRONMENT

(75) Inventors: Jürgen Gittinger, Ludwigsburg (DE); Reinhard Becker, Ludwigsburg (DE); Martin Ossig, Tamm (DE)

(73) Assignee: FARO TECHNOLOGIES, INC., Lake Mary, FL (US)

(21) Appl. No.: 13/389,026

(22) PCT Filed: Jul. 29, 2010
(86) PCT No.: PCT/IB2010/002258

§ 371 Date: Feb. 23, 2012

Related U.S. Application Data
(60) Provisional application No. 61/299,146, filed on Jan. 28, 2010.

(30) Foreign Application Priority Data
Aug. 20, 2009 (DE) 10 2009 038 964.4

(51) Int. Cl. G01B 11/24

(52) U.S. Cl. 356/612

(57) ABSTRACT

A method for optically scanning and measuring an environment of a laser scanner includes the steps of emitting an emission light beam by a light emitter, reflecting the emission light beam by a mirror into the environment, wherein several complete revolutions are made during rotation of the measuring head, receiving a reception light beam by a light receiver via the mirror, which reception light beam is reflected by an object in the environment of the laser scanner , and determining for a multitude of measuring points of the scan, at least the distance of the center to the object, wherein the measuring head makes more than half a revolution for the scan, and wherein at least some measuring points are doubly determined.

### CROSS REFERENCE TO RELATED APPLICATIONS

The present application is a National Stage Application of PCT Application No. PCT/IB2010/002258 filed on Jul. 29, 2010, which claims the benefit of U.S. Provisional Patent Application No. 61/299,146 filed on Jan. 28, 2010, and of pending German Patent Application No. DE 10 2009 038 964.4, filed on Aug. 20, 2009, and which are hereby incorporated by reference.

### BACKGROUND OF THE INVENTION

The invention relates to a method for optically scanning and measuring an environment.

By means of a device such as is known for example from U.S Published Patent Application No. 2010/0134596, which device is designed as a laser scanner, a method of the kind mentioned in the introduction can be carried out. Due to damage on the laser scanner or to other error sources, the scans may become incorrect.

### SUMMARY OF THE INVENTION

Embodiments of the present invention are based on the object of improving a method of the type mentioned hereinabove.

By turning the measuring head for more than the necessary half turn, at least some measuring points are doubly determined. Then such a point is determined twice using different mechanical arrangements of the laser scanner; another combination of horizontal and vertical angles points to the same point in space. Although it is still the same laser scanner, the two different arrangements result in two different scans, i.e. two different scans similarly produced by two different laser scanners. However, the two different scans are correlated in a defined manner.

The additional information, obtained from the doubly determined measuring points, can be used for error correction. The coordinates of the measuring points, i.e. their angle coordinates with priority, can thus be corrected. The more double measuring points that are available, the better the correction that can take place. Depending on the kind of error, a single calibration of the laser scanner, which is used further for subsequent scans without double measuring points, is sufficient. Dynamic errors can be corrected as well, however. The method can also be used for verifying data: the measured data are verified, if they are consistent, i.e. if, with the double measuring points, there are no and/or sufficiently small deviations.

As distinct from measuring in two circles positions which, for example, are used for determining tilting-axes errors, in the present invention it is not the same point at the firmament which is measured, but measuring takes place twice with, theoretically, identical coordinates, and a potential error is determined from the coordinates of the doubly measured objects.

### BRIEF DESCRIPTION OF THE DRAWINGS

The invention is explained in more detail below on the basis of exemplary embodiments illustrated in the drawings, in which

FIG. 1 is a schematic illustration of the optical scanning and measuring of an environment of a laser scanner, shown in partially sectional view; and;

FIG. 2 is an illustration of the axes and angles.

### DETAILED DESCRIPTION OF THE INVENTION

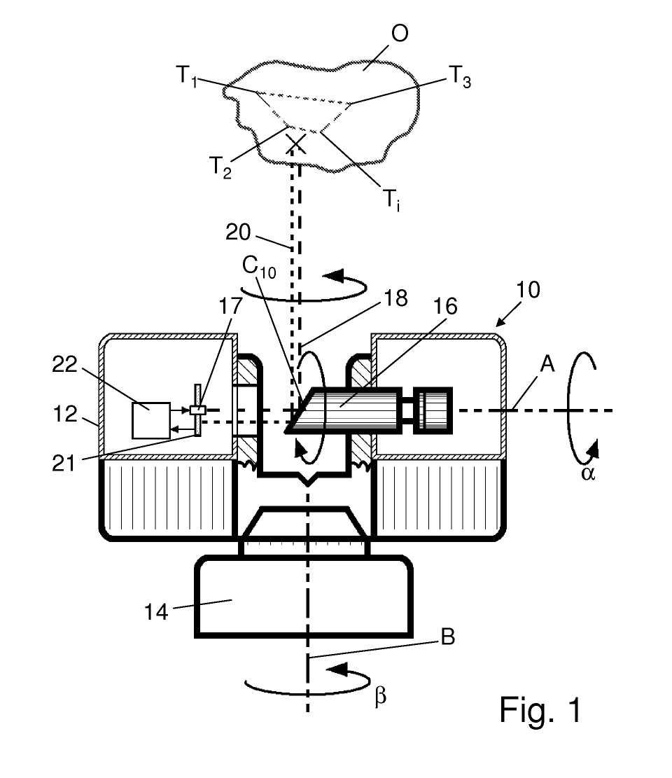

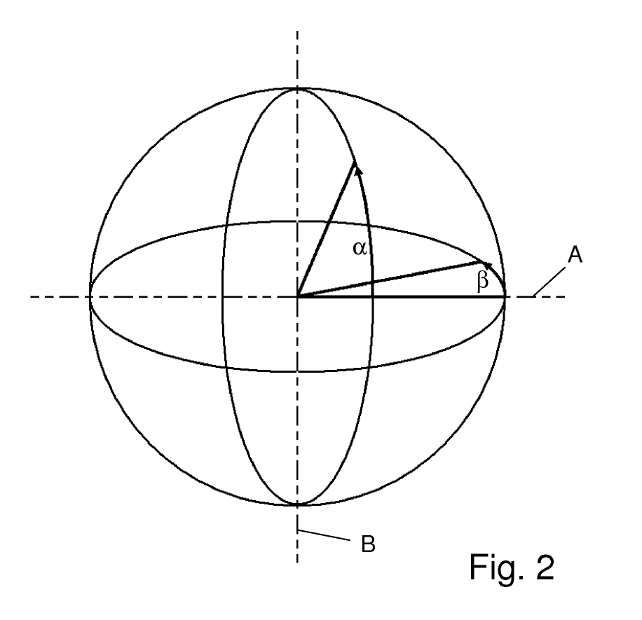

Referring to FIGS. 1 and 2, a laser scanner 10 is provided as a device for optically scanning and measuring the environment of the laser scanner 10. The laser scanner 10 has a measuring head 12 and a base 14. The measuring head 12 is mounted on the base 14 as a unit that can be rotated about a vertical axis. The measuring head 12 has a mirror 16, which can be rotated about a horizontal axis. The horizontal axis of the mirror 16 is designated first axis A, the assigned rotational angle of the mirror 16 first angle α, the vertical axis of the measuring head 12 second axis B, the assigned rotational angle of the measuring head 12 second angle β, and the intersection point of the first axis A with the second axis B the center C₁₀ of the laser scanner 10.

The measuring head 12 is further provided with a light emitter 17 for emitting an emission light beam 18. The emission light beam 18 may be a laser beam in the visible range of approximately 340 to 1000 nm wave length, such as 790 nm; also other electro-magnetic waves having, for example, a greater wave length can be used, however. The emission light beam 18 is amplitude-modulated, for example with a sinusoidal or with a rectangular-waveform modulation signal. The emission light beam 18 is emitted by the light emitter 17 onto the mirror 16, where it is deflected and emitted to the environment. A reception light beam 20 which is reflected in the environment by an object O or scattered otherwise, is captured again by the mirror 16, deflected and directed onto a light receiver 21. The direction of the emission light beam 18 and of the reception light beam 20 results from the angular positions of the mirror 16 and the measuring head 12, i.e. the two angles α and β, which depend on the positions of their corresponding rotary actuators which, again, are registered by one encoder each. A control and evaluation unit 22 has a data connection to the light emitter 17 and to the light receiver 21 in measuring head 12, whereby parts of it can be arranged also outside the measuring head 12, for example a computer connected to the base 14. The control and evaluation unit 22 determines, for a multitude of measuring points X, the distance d between the laser scanner 10 and the illuminated point at object O, from the propagation time of emission light beam 18 and reception light beam 20. For this purpose, the phase shift between the two light beams 18 and 20 is determined and evaluated.

Scanning takes place along a circle by means of the relatively quick rotation of the mirror 16 about the first axis A, i.e. the first angle α each time makes a revolution) (360°, wherein, however, an angle range of approximately 40° cannot be used, since the emission light beam 18, within this angle range, is directed onto the base 14 and onto the part of the measuring head 12 which is mounted on it. By virtue of the relatively slow rotation of the measuring head 12 about the second axis B, relative to the base 14, the whole space is scanned step by step, by means of the circles. The mirror 16 at the same time carries out several complete revolutions, while the measuring head 12 rotates. The entity of measuring points X of such a measurement is designated as a scan. For such a scan, the center C₁₀ of the laser scanner 10 defines the stationary reference system of the laser scanner 10, in which the base 14 rests. Further details of the laser scanner 10 and particularly of the design of measuring head 12 are described for example in U.S. Pat. No. 7,430,068 and DE 20 2006 005 643, the contents of which are incorporated by reference.

Due to its design, the laser scanner 10 defines a spherical-coordinate system with the center C₁₀, the distance d as radius and the two angles α and β. In spherical coordinates, however, in principle one angle makes a complete revolution, and the other angle runs only half as far. Since, in the laser scanner of embodiments of the present invention, the first angle α already makes complete revolutions, a complete scan with regard to the coordinates has been made, when the second angle β has run from 0° to 180°, i.e. when the measuring head 12 has carried out half a turn.

The initial position (β=0°) of the measuring head 12 defines two hemispheres separated by a vertical plane. When second angle β is 180°, one hemisphere has been scanned with a laser beam spot of the emission light beam 18 running from the bottom to the top, and the other one with a laser beam spot of the emission light beam 18 running from the top to the bottom. In embodiments of the present invention, the measuring head 12, however, makes more than half a revolution (β>180°), particularly one complete revolution. Although the mirror 16 is still rotating in the same direction, the spot of the emission light beam 18 is now running in the opposite direction in each hemisphere. The same laser scanner 10 is scanning with the opposite (inverse) mechanical arrangement. Another combination of first angle α and second angle β points to the same point in space, i.e. the same point in space is described by two different combinations of first angle α and second angle β.

Several or all measuring points X are thus determined twice. If the laser scanner 10 was in an ideal state as well as ideally set up, the double measuring points X would be identical. However, damage to the laser scanner 10, for example bent bearings of mirror and/or measuring head, may lead to the two axes A and B no longer intersecting in the center C₁₀ and/or no longer being exactly perpendicular to each other. In case of such errors, the double measuring points X deviate from each other, i.e. actually corresponding measuring points X have deviating coordinates. These deviations (inconsistency of measuring points X) can now be used for calibrating the laser scanner 10 and thus for correcting the measuring points X. When doing so, the measuring points X can be reduced again, so that all corrected measuring points X are available only once.

In order to search for corresponding measuring points X, methods can be used, for example, as they have been developed for joining together several scans. Before making the scan, several targets T₁, T2, . . . can be suspended in the environment, i.e. special objects O or special parts of an object O. Due to the rotation of measuring point 12 by a second angle β of more than 180°, at least one area of the scan overlaps in such a way that some (preferably at least three) targets T₁, T₂, . . . are doubly registered. Spheres or checkerboard patterns have turned out to be particularly suitable (and therefore preferred) targets T₁, T₂, . . . The targets T₁, T₂, . . . must then be localized and identified in the scan. The deviations of the measuring points X which correspond to each other result from the deviations of the coordinates of the targets T₁, T2, . . .

Since the deviations of the coordinates of the measuring points X should not be relatively too large, the measuring points X which correspond to each other can be looked for also by means of error-correction methods, for example by means of least square error method.

The more the measuring head 12 turns, i.e. the bigger the second angle β gets within the range of 180° and 360° is, the better the calibration becomes. For recognizing dynamic errors, the measuring point 12 may be carried out with more than one complete revolution.

The data is checked with respect to inconsistencies. If there are no or only sufficiently small deviations or other inconsistencies at the measuring points X, the method according to embodiments of the present invention nearly automatically supplies a verification of the data. If the inconsistencies exceed a certain limit, severe errors may be detected, for example, if the orientation of the laser scanner 10 changes during the scan, due to a strike.

The laser scanner 10 may comprise various sensors, e.g. thermometer, inclinometer, altimeter, compass, gyro compass, GPS etc., which may be connected to the control and evaluation unit 22. By use of such sensors, the operating conditions of the laser scanner 10, defined by certain parameters like geometrical orientation or temperature, are monitored. If one or more parameters show a drift, the associated sensors will detect the drift, which may be compensated by the control and evaluation unit 22. By use of such sensors, a sudden change of the operating conditions can also be detected, e.g. a strike changing the orientation of the laser scanner 10, or a shift of the laser scanner 10. If the amount of said change cannot be detected exactly enough, the scanning operation will be interrupted or aborted. If the amount of the change of the operating conditions can be approximately estimated, the measuring head 12 may turn back some degrees (until an overlap with the region scanned before the sudden change is available), and the scanning operation is continued. The two different parts of the scan may be combined by evaluating the overlapping region.

The method according to embodiments of the present invention also allows to discard the part of the scan before or after the sudden change of the operating conditions, i.e. the smaller part.

1. A method for optically scanning and measuring an environment of a laser scanner having a measuring head with a light emitter and a light receiver, a mirror rotatable about a first axis relative to the measuring head, a base relative to which the measuring head is rotatable about a second axis, a control and evaluation unit, and a center which, for a scan, defines the stationary reference system of the laser scanner and the center of the scan, the method comprising the steps of:
emitting an emission light beam from the light emitter;
reflecting the emission light beam by the mirror into the environment, wherein several complete revolutions are made during rotation of the measuring head;
receiving a reception light beam via the mirror by the light receiver, the reception light beam being reflected by an object in the environment of the laser scanner;
determining by the control and evaluation unit for a multitude of measuring points of the scan, at least a distance of the center to the object, wherein the measuring head makes more than half a revolution for the scan, and wherein at least some of the measuring points are doubly determined.

2. The method of claim 1, wherein the measuring head makes a full revolution for the scan, thereby determining all of the measuring points twice.

3. The method of claim 1, wherein deviations of the doubly determined measuring points are determined and used for calibration and compensation of the laser scanner.

4. The method of claim 3, wherein the deviations of the doubly determined measuring points are used for correction of all of the measuring points.

5. The method of claim 3, wherein deviations of coordinates of those one or more of the measuring points which actually correspond to each other are determined.

6. The method of claim 5, wherein the deviations of the coordinates of the measuring points which actually correspond to each other are determined by error-correction methods.

7. The method of claim 1, wherein the environment of the laser scanner is provided with targets.

8. The method of claim 7, wherein, due to the rotation of the measuring head, areas of the scan overlap in such a way that some of the targets are doubly registered.

9. The method of claim 1, wherein a verification of the data is carried out by the measuring points doubly determined.
